(19) United States
(12) Patent Application Publication
(10) Pub. No.: US 2007/0145079 A1
(43) Pub. Date: Jun. 28, 2007

(54) BARRIER PACKAGE AEROSOL DISPENSER

(76) Inventors: ANTONINO CASAMENTO, Brampton (CA); Brian Webster, Mississauga (CA); Ralph Webster, Mississauga (CA)

Correspondence Address: SMART AND BIGGAR, 438 UNIVERSITY AVENUE, SUITE 1500 BOX 111, TORONTO, ON, M5G2K8, CA

(21) Appl. No.: 11/613,837

(22) Filed: Dec. 20, 2006

Related U.S. Application Data
(60) Provisional application No. 60/752,908, filed on Dec. 23, 2005.

(51) Int. Cl. B67D 5/42; B65D 35/28

(52) U.S. Cl. 222/386.5; 222/95

(57) ABSTRACT

A barrier package for an aerosol container may have a body with a pleated plastic side wall which is strengthened as a result of formation of the side wall by re-heating, stretching and blow molding a pre-form. In fabricating a barrier package into an aerosol container, the package with attached valve cup may be positioned in the mouth of a canister so as to leave the mouth open and propellant injected into the mouth. An aerosol container may have a barrier package with a self-supporting pleated plastic body.

### CROSS-REFERENCE TO RELATED APPLICATIONS

The present application claims the benefit of prior provisional application Ser. No. 60/752,908, filed Dec. 23, 2005, the contents of which are hereby incorporated herein by reference.

### BACKGROUND

This invention relates to a barrier package and to an aerosol dispenser incorporating such a package.

Aerosol dispensers are used to dispense a wide variety of products. For certain products it is desirable, or necessary, to isolate the product from the propellant. As described in U.S. Pat. No. 4,238,264 issued Dec. 9, 1980 to Pelton, one manner of achieving this is to introduce a laminated plastic film liner into a canister with a special tool that creates a vacuum inside the liner so that the liner collapses onto a central tube to have a diameter less than that of the canister opening. The open end of the liner may be glued to the lip of the canister opening and the liner charged with product before attaching a valve cup over the canister opening. Propellant may be introduced through a charging port at the base of the canister and the charging port sealed.

This invention seeks to avoid some of the drawbacks of known barrier package aerosol dispensers.

### SUMMARY

A barrier package for an aerosol container may have a body with a pleated plastic side wall which is strengthened as a result of formation of the side wall by re-heating, stretching and blow molding a pre-form. In fabricating a barrier package into an aerosol container, the package with attached valve cup may be positioned in the mouth of a canister so as to leave the mouth open and propellant injected into the mouth. An aerosol container may have a barrier package with a self-supporting pleated plastic body.

In accordance with this invention, there is provided a barrier package for an aerosol container, comprising: a neck; a longitudinally extending body extending from said neck, said body defining a cavity open only at said neck; said body having a side wall, said side wall having a plurality of longitudinally extending pleats; said body being fabricated of a plastic such that said body is self-supporting; said side wall having an increased strength resulting from formation of said side wall by re-heating, stretching, and blow molding a pre-form.

In accordance with another aspect of the present invention, there is provided an aerosol dispenser comprising: a canister having a mouth opening; a barrier package having: a neck; a longitudinally extending body depending from said neck, said body defining a cavity open only at said neck; said body having a side wall, said side wall having a plurality of longitudinally extending pleats; said body being fabricated of a plastic such that said body is self-supporting; pressurised gaseous propellant between said canister and said barrier package.

In accordance with a further aspect of the present invention, there is provided a method of fabricating a barrier package aerosol dispenser comprising: press fitting a valve cup into an opening of a neck of a longitudinally extended self-supporting plastic barrier package having longitudinally extending pleats so that said valve cup is attached to said package; positioning said valve cup with attached package with respect to a canister having a mouth such that said package extends into said mouth but said mouth remains open; charging said canister with propellant through said mouth around said barrier package; seating a lip of said neck of said barrier package on an edge of said mouth and joining said valve cup to said edge of said mouth.

### BRIEF DESCRIPTION OF THE DRAWINGS

In the figures which illustrate an example embodiment of the invention,

FIG. 1 is a partially cut away front view of a charged aerosol dispenser made in accordance with an embodiment of this invention,

FIG. 2 is an exploded front view of the components of the aerosol dispenser of FIG. 1,

FIG. 3 is a perspective view of a barrier package made in accordance with an embodiment of this invention,

FIG. 4 is a front view of the barrier package of FIG. 3,

FIG. 5 is a cross-sectional view along the lines A-A of FIG. 4,

FIG. 6 is a perspective view of a pre-form for use in forming the barrier package of FIG. 3, and

FIG. 7 is a cross-sectional view of the pre-form of FIG. 6.

### DETAILED DESCRIPTION

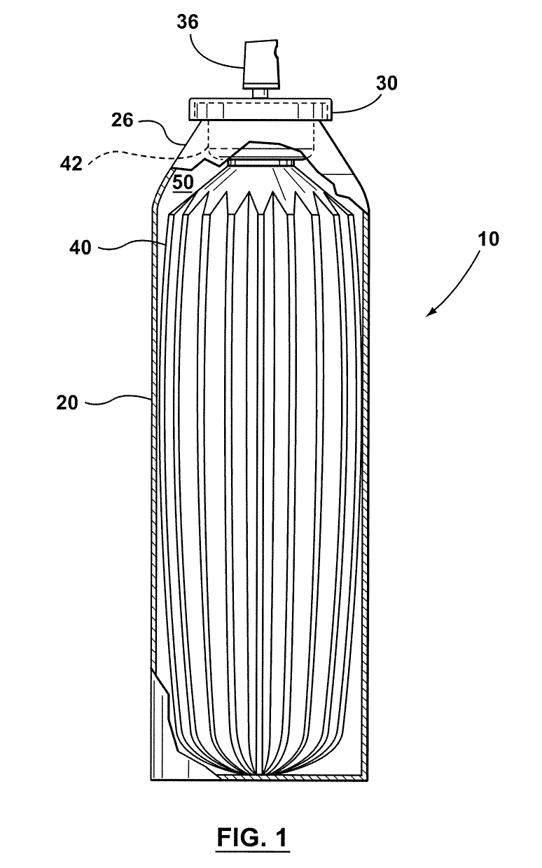

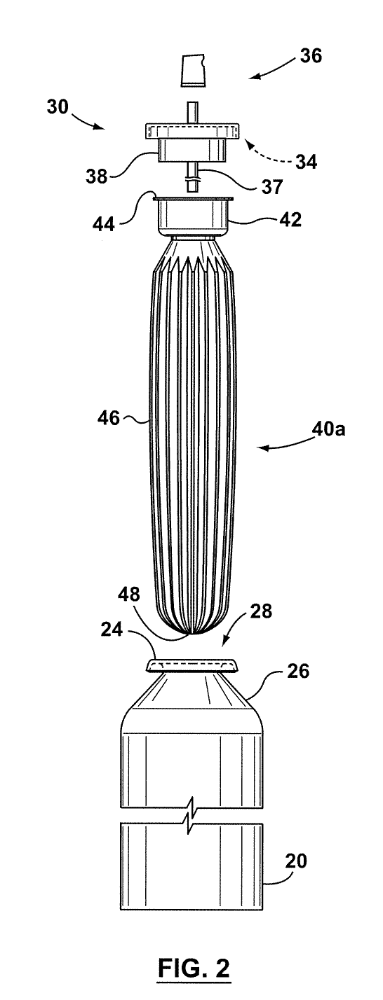

Turning to FIGS. 1 and 2, an aerosol dispenser 10 has a canister 20 with a crown 26 having an open mouth 28 bounded by a filler ring 24 formed by an annular, outwardly curled lip. A valve cup 30 has a mating peripheral outward curled lip 34 so that the cup may be crimped to the filler ring 24 in order to close open mouth 28. Cup 30 incorporates a valve mechanism 36. The base 38 of the valve cup has a reduced diameter.

A barrier package 40 is contained in canister 20. It has a neck 42 also formed with an annular curled lip 44 which, when the aerosol dispenser is assembled, is compressed between the filler ring 24 and the curled lip 34 of the cup 30. The barrier package 40 serves to separate the usable contents or product, which is not illustrated but which is contained within the package 40, from the propellant 50 which is confined between the walls of the package 40 and the walls of the canister 20.

The valve mechanism of valve cup 30 has a valve stem 37 which extends inside the barrier package to proximate the convex basal tip 48 of the package.

When product is injected into the barrier package 40, it may expand from its original undeformed size illustrated by package 40a of FIG. 2 to an expanded filled size, illustrated by the barrier package 40 of FIG. 1.

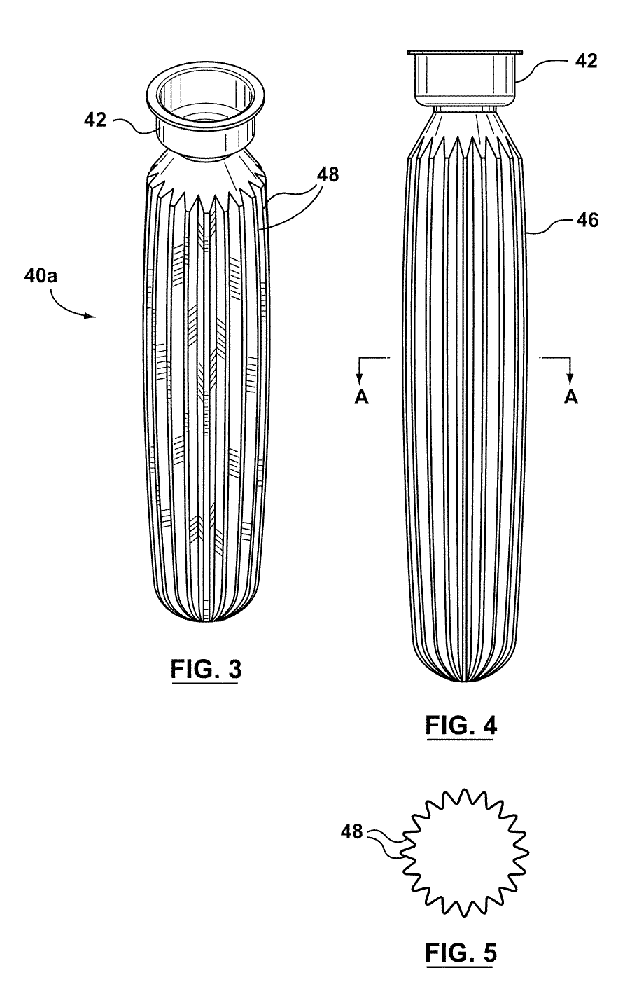

Turning to FIGS. 3 to 5, it will be seen that barrier package 40a is one continuous piece with an elongate body 46 depending from neck 42. Body 46 has a plurality of longitudinally directed pleats 48 extending about its circumference. Package 40a is made of a plastic material, such as a polymer plastic, such that the package is self-supporting but has some flexibility. For example, package 40a may be made of Poly Ethylene Terephthalate (PET) or Polypropylene. The diameter proximate the convex tip 48 of body 46 is preferably no greater than that of open mouth 28 of canister 20 so that the package 40a may be readily inserted into canister 20. The wall of body 46 may have a thickness of about 0.3 mm; the wall of the neck may be thicker, about 1.5 mm, such that the neck is significantly more rigid than the body, but flexible enough to allow for proper assembly without cracking.

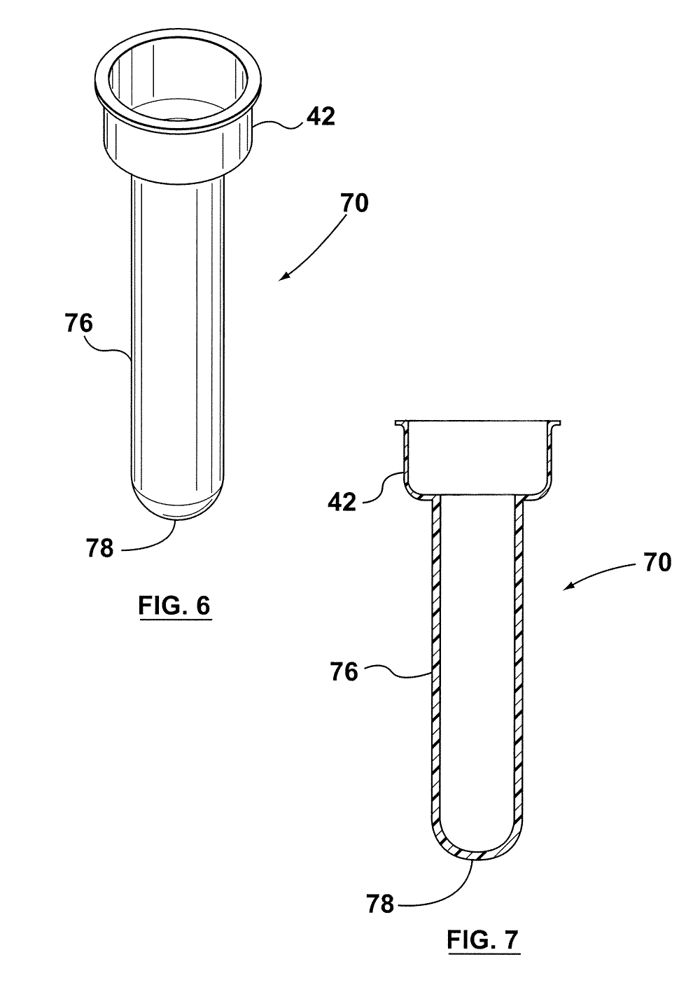

Barrier package 40a may be formed by re-heating, stretching and blow molding a pre-form, such as the pre-form shown in FIGS. 6 and 7. Turning to these figures, pre-form 70 has a neck 42 which is the same as (i.e., is indistinguishable from) the neck 42 of package 40a. However, the body 76 of the pre-form, which depends from neck 42, is substantially cylindrical and terminates in a convex basal tip 78. The wall of the body 76 and neck of the pre-form may have a thickness of about 1.5 mm.

To form package 40a from the pre-form, the sides of the pre-form are first heated so that they become ductile. Then the pre-form may be introduced into a mold having relatively cold walls defining a mold cavity that is shaped as the negative of the body 46 of package 40a. A rod may then be inserted into the pre-form and pressed against its basal tip 78 to stretch the body 76. This has the effect of orienting the plastic material at a molecular level, thereby strengthening the plastic material. Next pressurised air may be injected into the pre-form so that its side walls expand into contact with the cavity walls of the mold and freeze. The resultant package 40a may then be dropped from the mold.

To assemble and charge the aerosol dispenser 10, the barrier package 40a may be first inserted into the canister 20 until the lip 44 of its neck 42 abuts the filling ring 24. Next, the smaller diameter base 38 of the valve cup may be pressed into the neck 42 of the barrier package 40a. The relative diameters of the base of the cup 30 and the opening in the neck of the barrier package 40a are such that this is an interference fit, which results in the neck stretching as it receives the base 38 of the cup 30. This also results in joining the valve cup and barrier package in a sufficiently robust manner to allow further assembly. Next a vacuum may be drawn in the barrier package 40a through the valve stem 37 of the valve assembly 36 and the valve cup 30, with attached barrier package, lifted a short distance off the filling ring 24. This allows injection of propellant into the canister around the exterior of the barrier package through the mouth 28 of the canister. The valve cup, with attached barrier package, is then again seated on the fill ring 24. The lip 34 of the cup may then be crimped to the fill ring, sandwiching the lip 44 of the package between the fill ring 24 and the lip 34 of the cup.

Next product may be injected into the barrier package through the valve stem 37. This causes the wall of the body of the package to expand and such expansion may continue until the wall of the body abuts the side wall of the canister 20. The pleats of the body facilitate expansion of the package. Additionally, because the package is made of plastic, the walls of the body thin as the body expands. Indeed, the expanded package 40 (FIG. 1) may have a wall thickness of about 0.15 mm to 0.2 mm.

As product is dispensed through the valve mechanism 36, the package 40 will contract from the pressure exerted by the propellant. The pleats assist in allowing the package to collapse in a predictable fashion as product is dispensed. Specifically, because the package 40 is made of a self-supporting plastic material, the pleats act as longitudinal reinforcing ribs. Consequently, the pleats resist longitudinal contraction of the package. On the other hand, the pleats more freely permit radial collapse of the package. Therefore, as product is dispensed, the package generally radially contracts to a point where opposite walls of the body may touch. And even at this point, the longitudinal pleats provide channels communicating the length of the package. Thus, the pleats resist the possibility of the package collapsing in any way which traps product in the package.

While the canister 20 has been shown as having a cylindrical side wall, the canister side wall could also have a non-cylindrical shape. In such case, when the package is charged with product, the package would generally assume this non-cylindrical shape as the package expanded to contact the canister side wall.

Any pressurised gas may be used as a propellant, such as air, nitrogen, a hydrocarbon, or a hydrofluoroalcan. And the product may be any product for which it is desired to separate the product from the propellant. However, of course, neither the propellant nor the product should be caustic to the material of which the package 40 is fabricated.

Package 40 facilitates recycling of the aerosol container since the package may be burned off in a recycling process thereby avoiding the expensive, and therefore generally infeasible, task of separating the package 40 from the canister 20.

Modifications will be apparent to those skilled in the art and, therefore, the invention is defined in the claims.

What is claimed is:

1. A barrier package for an aerosol container, comprising:
a neck;
a longitudinally extending body extending from said neck, said body defining a cavity open only at said neck;
said body having a side wall, said side wall having a plurality of longitudinally extending pleats;
said body being fabricated of a plastic such that said body is self-supporting;
said side wall having an increased strength resulting from formation of said side wall by re-heating, stretching, and blow molding a pre-form.

2. The barrier package of claim 1 wherein said neck is fabricated of plastic and said barrier package is one continuous piece.

3. The barrier package of claim 2 wherein said body side wall is thinner than a side wall of said neck.

4. The barrier package of claim 3 wherein said neck and said body are fabricated of a polymer plastic.

5. The barrier package of claim 4 wherein said polymer plastic is Poly Ethylene Terephthalate.

6. The barrier package of claim 4 wherein said polymer plastic is Polypropeylene.

7. The barrier package of claim 4 wherein said body side wall is about 0.3 mm thick.

8. The barrier package of claim 4 wherein said body side wall is about 0.3 mm thick and said neck side wall of said neck is about 1.5 mm thick.

9. An aerosol dispenser comprising:
a canister having a mouth opening;
a barrier package having
a neck;
a longitudinally extending body depending from said neck, said body defining a cavity open only at said neck;
said body having a side wall, said side wall having a plurality of longitudinally extending pleats;
said body being fabricated of a plastic such that said body is self-supporting;
pressurised gaseous propellant between said canister and said barrier package.

10. The dispenser of claim 9 wherein said barrier package has a first undeformed state and a second expanded state after introduction of product to said barrier package, said barrier package, in said undeformed state, having a maximum diameter proximate a basal tip no greater than a diameter of said mouth opening of said canister.

11. A method of fabricating a barrier package aerosol dispenser comprising:
press fitting a valve cup into an opening of a neck of a longitudinally extended self-supporting plastic barrier package having longitudinally extending pleats so that said valve cup is attached to said package;
positioning said valve cup with attached package with respect to a canister having a mouth such that said package extends into said mouth but said mouth remains open;
charging said canister with propellant through said mouth around said barrier package;
seating a lip of said neck of said barrier package on an edge of said mouth and joining said valve cup to said edge of said mouth.

12. The method of claim 11 wherein said barrier package is inserted into said canister and said lip of said neck is seated on said edge of said mouth prior to said press fitting so that said canister acts as a support for said barrier package during said press fitting.

13. The method of claim 12 wherein said positioning comprises lifting said valve cup with attached package to unseat said lip of said neck from said edge of said mouth to thereby open said mouth.

14. The method of claim 13 further comprising:
charging said barrier package with product so that said barrier package expands into contact with walls of said canister.

15. The method of claim 14 wherein said charging said barrier package with product comprises injecting product through a valve assembly in said valve cup.
